(19) United States
(12) Patent Application Publication
(10) Pub. No.: US 2004/0064812 A1
(43) Pub. Date: Apr. 1, 2004

(54) System and method for updating software versions

(75) Inventor: Osamu Tachiyama, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/259,833

(22) Filed: Sep. 30, 2002

(51) Int. Cl. G06F 9/44; G06F 9/445

(52) U.S. Cl. 717/170; 717/177

(57) ABSTRACT

A system and method for updating a version of client software in a client computer, the client software enabling the client computer to communicate properly with a hardcopy device, includes receiving a job from the client computer, the job including information regarding a version of the client software in the client computer. A determination is made of whether the version of the client software of the client computer is an up-to-date version. The up-to-date version of the client software is provided to the client computer if the version of client software of the client computer is not the up-to-date version.

### FIELD OF THE INVENTION

The present invention relates generally to updating software version, and more particularly to a system and method for automatically updating versions of software running on client computers.

### BACKGROUND OF THE INVENTION

Computer networks typically include one or more hardcopy devices. A hardcopy device may be a printer, a copier, a scanner, a fax, a plotter or some combination thereof, such as a multi-function peripheral (MFP). Users connected to the network may send job commands to the hardcopy devices to perform applicable functions, such as a print job for a printer to print a document. To properly communicate the job commands to the hardcopy devices, the user's client personal computer (PC), such as a client PC, includes client software, such as a software driver, that is associated with the particular hardcopy device. The client software, when properly loaded in the client PC, enables the user to submit jobs to the hardcopy device associated with the client software.

The software in the hardcopy device may be updated, such as to fix bugs in the existing software or to add or accommodate new features. This update of the software in the hardcopy device is typically performed by an administrator in the network in which the hardcopy device is located. When the software in the hardcopy device is updated, it may be necessary to update the corresponding client software in the client PCs that use that hardcopy device. In general, it is then incumbent upon the user to update manually their client PC with the updated client software of the associated hardcopy device. This obligation for the user results in multiple problems. First, the user may not know about the update to the hardcopy device, and therefore be unaware of the necessity of updating the client software on the client PC of the user. In addition, even when the user is aware, the user needs to find time to perform the manual update of the client software. Until the client software is updated, the user may be unable to have jobs processed properly by the associated hardcopy device.

### SUMMARY OF THE INVENTION

Briefly, in one aspect of the invention, a method for updating a version of client software in a client computer, the client software enabling the client computer to communicate properly with a hardcopy device, includes receiving a job from the client computer, the job including information regarding a version of the client software in the client computer. A determination is made of whether the version of the client software of the client computer is an up-to-date version. The up-to-date version of the client software is provided to the client computer if the version of client software of the client computer is not the up-to-date version.

### BRIEF DESCRIPTION OF THE DRAWINGS

FIG. 1 is a block diagram of a communication system consistent with the present invention.

FIG. 2 is a flow diagram for updating the client software on a client PC consistent with the present invention.

FIG. 3 is a flow diagram for updating software on a hardcopy device and associated client software on client PCs consistent with the present invention.

### DETAILED DESCRIPTION OF THE PREFERRED EMBODIMENT

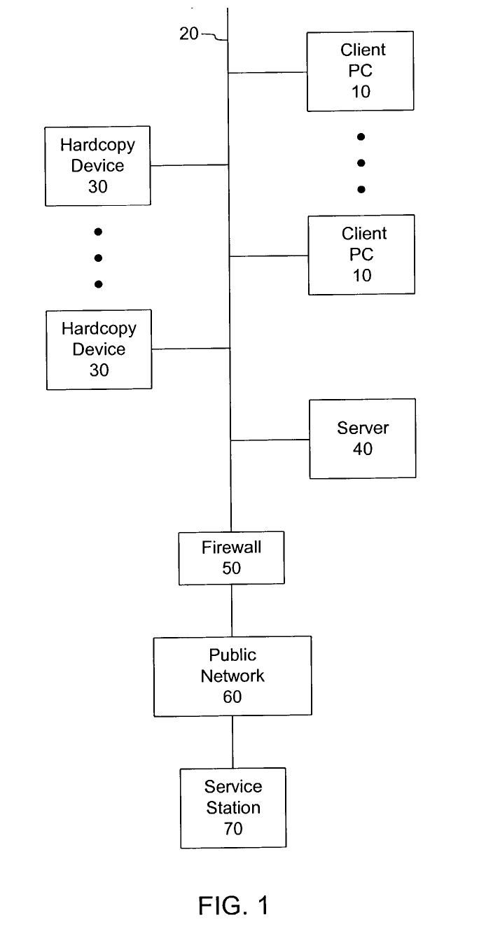

FIG. 1 is a block diagram of a communication system consistent with the present invention. As shown in FIG. 1, the communication system includes one or more client PCs 10, a network 20, one or more hardcopy devices 30, a server 40, a firewall 50, a public network 60 and a service station 70. Each of the client PCs 10, each of the hardcopy devices 30, the server 40 and the firewall 50 are coupled to the network 20. The network 20 is preferably implemented as a local network, such as a LAN, and can use any applicable network configuration, such as Ethernet or Token Ring.

The firewall 50 protects the network 20 from unwanted access by users external to the network 20. The firewall 50 can also limit the data or information transmitted out of the network 20. The firewall 50 further serves as a gateway for users and devices of the network 20 to the public network 60. The public network 60 can be, for example, the Internet or any other type of wide area or geographically distributed network of devices. Among the devices that can be accessed by the network 20 is the service station 70, which can also access devices on the network 20.

The client PCs 10 and the server 40 each include a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the client PCs 10 and server 40 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

The client PCs 10 and server 40 can transmit a requested code for an application program through the Internet, an ISP, the local network and the communication interface. The received code can be executed by the CPU in the client PC or server as it is received, stored in the storage device, or stored in some other non-volatile storage for later execution. In this manner, a user at the client PC 10 or server 40 may obtain application code in the form of a carrier wave. The implementation and functioning of the clients PCs 10 and the server 40 is also applicable to the service station 70. Additional functionality of the service station 70 will be described herein.

The hardcopy device 30 is a device which can perform the function of, for example, a printer, a fax machine, a copier, a plotter, a scanner or any other functional device that generates or processes images or text. Hardcopy devices 30 can also be devices, such as multi-function peripherals (MFPs), which are capable of performing the functions of two or more image processing devices, such as a combination of any of printing, faxing, copying, plotting and scanning. Like the client PC 10, the hardcopy device 30 may have a CPU, a main memory, a ROM, a storage device and a communication interface all coupled together via a bus. The hardcopy device 30 may also have a communication interface to provide a two-way data communication coupling via a network link to the network 20. The network link to the network 20 enables the hardcopy device 30 to receive data from and to output data to the client PC 10. Instead of a network link, hardcopy devices 30 may use a Universal Serial Bus (USB) to connect to a USB port on the client PC 10.

In operation, the client PCs 10 communicate with the hardcopy devices 30 via the network 20 or via a more direct connection, such as the USB. This communication enables the client PC 10 to request the hardcopy device 30 to perform a function, such as print a document or send or receive a fax. In addition, the client PC 10 can request information from the hardcopy device 30.

To communicate with the hardcopy device 30, the client PC 10 may use a network protocol such as SNMP, which is a protocol for monitoring and managing systems and devices in a network. The functions supported by the protocol are the request and retrieval of data, the setting or writing of data, and traps that signal the occurrence of events. The data being monitored and managed is defined by a management information base (MIB). A MIB includes the specification and formal description of a set of objects and variables that can be read and possibly written using the SNMP protocol. SNMP and similar communication protocols can also be used with non-networked connections, such as USB, FireWire and IEEE 1284 (Parallel).

To process jobs received from the client PCs 10, the hardcopy device 30 can include software that enables the hardcopy device 30 to interpret the job and execute the operation indicated in the job. The client PCs 10 can also include client software, such as software drivers, that enable the client PCs 10 to communicate jobs properly to the hardcopy device.

For example, to prepare and process print jobs, the client PC 10 can generate the print job formatted in a printer language such as printer control language (PCL) or post script (PS). The print job includes a header section having instructions and commands about how to process the print job, as well as other related information. The print job also includes the image data to be printed by the hardcopy device 30. The hardcopy device 30 receives the print job from the client PC 10. The hardcopy device can include a raster image processor (RIP), which is a hardware-software combination that converts the image data included in the job into a bit-mapped image based on the image data and the header information in the job. This preparation and processing of print jobs is similarly applicable to other types of jobs such as, for example, fax, print or scan jobs, with corresponding specific software and/or hardware for accommodating those types of jobs.

If at any time the software in the hardcopy device 30 or the client software in the client PCs 10 has an error or bug, or needs to be updated to accommodate new features or parameters, the software in each of them needs to be updated. The update of the software in the hardcopy device 30 can be performed by an administrator of the network 20. Alternatively, an operator at the service station 70 can download the updated software via the public network 60. Updates to the client software in the client PCs 10 can be performed by the administrator of the network 20, the operator at the service station 70 or the user of the client PC 10.

Typically, the software in the hardcopy device 30 is updated before the update to the client software in the client PC 10. After updating the hardcopy device 30, the client software in the client PCs is updated. Until the client software in the client PC 10 is updated, however, jobs submitted by the client PC 10 to the hardcopy device 30 with the updated software may not be processed properly.

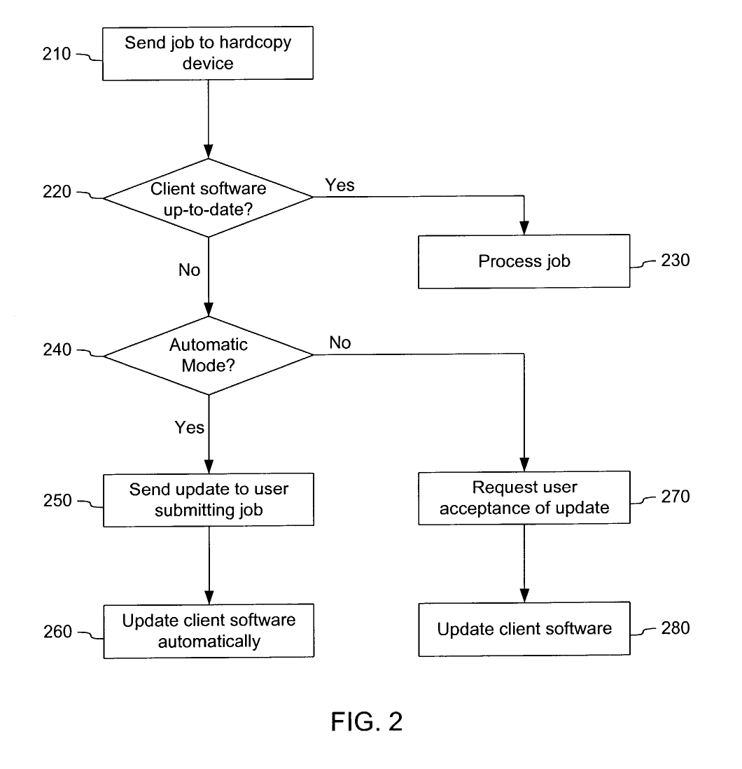

FIG. 2 is a flow diagram for updating the client software on a client PC consistent with the present invention. As shown in FIG. 2, a user first sends a job to a hardcopy device 30 (step 210). The type of job can be, for example, a print job, a fax job, a scan job, a copy job or any other type of job that may be performed by the hardcopy device 30. For purposes of the description herein, the job type will focus on print jobs. This focus, however, should not be seen as a limitation on the type of jobs to which systems and methods consistent with the present invention are applicable. One skilled in the art will would readily see the applicability to the other types of jobs and be able to implement such systems and methods for the other types of jobs based on this description.

The job sent to the hardcopy device includes any commands, parameters and settings for processing the job, as well as any other data, such as image data for a print job. As described above, the job can be implemented as a packet of data with the command/parameter/setting information placed in a header and the associated data in a separate section of the packet. The data in the job preferably includes information identifying the version of the client software present in the client PC 10 submitting the job. The representation of the version of the client software may be in the format of M.n, where M represents the generational versions of the client software, i.e., substantial changes to the software, and n represents improvements to the generational version, i.e., minor changes to the software. The version information is transmitted in the job in a manner that enables the receiving hardcopy device 30 to recognize that the data represents the version of the client software. For example, the job can include a tag understood by the hardcopy device 30 identifying the data as the version of the client software.

When the job is received, the hardcopy device 30 determines if the client software is up-to-date (step 220). To determine if the client software is up-to-date, the hardcopy device 30 first identifies the version of the client software identified in the job. As described above, the job can include a tagged data field that includes the information identifying the version of the client software.

The identified version is then checked to determine whether the client software is up-to-date. To make this determination, a storage area can be maintained that identifies what version is the up-to-date version of the client software. The storage area can be maintained at the hardcopy device 30 or at a centralized storage location, such as the server 40. The identified version is compared to the value of the up-to-date version stored in the designated storage area.

If the comparison of the values indicates that the version of the client software identified in the job is up-to-date, the hardcopy device 30 processes the job (step 230). The hardcopy device 30 process the job in accordance with the data in the job, including any commands, parameters, settings or other data in the job. For example, if it is a print job, the hardcopy device 30 would print a document in accordance with the image data included in the job, as well as any special settings for processing the job.

If, however, the comparison of the values indicates that the version of the client software identified in the job is not up-to-date, it is then determined if the update of the client PC 10 is in automatic mode (step 240). If the client software is not up-to-date, the client software is updated to ensure that the job from the client PC 10 can be transmitted and processed properly by the applicable hardcopy device 10. Automatic mode means that the client software in the client PC 10 is updated automatically without input or intervention by the user at the client PC 10. When not in automatic mode, the user at the client PC 10 is prompted, such as by a pop-up window, to accept or refuse the update of the client software.

The automatic mode may be a default setting for the hardcopy device 30. For example, the default setting may be that client software associated with the hardcopy device 30 is automatically updated when the client software is determined to not be up-to-date. The default setting may be stored in a storage section in the hardcopy device 30 or in a centralized storage location, such as the server 40, which can maintain a table of settings for each of the hardcopy devices 30 in the network 20. Alternatively, each client PC 10 may have an individualized setting, such that the user at the client PC 10 can elect whether or not to be in automatic mode. The settings for each client PC 10 may be stored, for example, as a table maintained in the hardcopy device or in a centralized location, such as the server 40.

If the setting is for automatic mode, the updated client software is sent to the client PC 10 submitting the job (step 250). The updated client software can be provided, for example, by the hardcopy device 30, the server 40, or the service station 70. The client software in the client PC 10 is then updated automatically with the updated client software (step 260). This update is preferably done in the background of the client PC 10 so that it does not interrupt the operations of the user of the client PC 10.

If the setting is not for automatic mode, the user at the client PC is prompted to accept or refuse the update (step 270). The prompting can be, for example, a pop-up window at the client PC 10, which notifies the user that an update is available and requests the user to accept or refuse the update. If the user refuses, then the update is not performed. If the user accepts, however, then the client software at the client PC is updated with the updated client software (step 280). As described above, the updated client software can be provided to the client PC 10 by the hardcopy device 30, the server 40 or the service station 70.

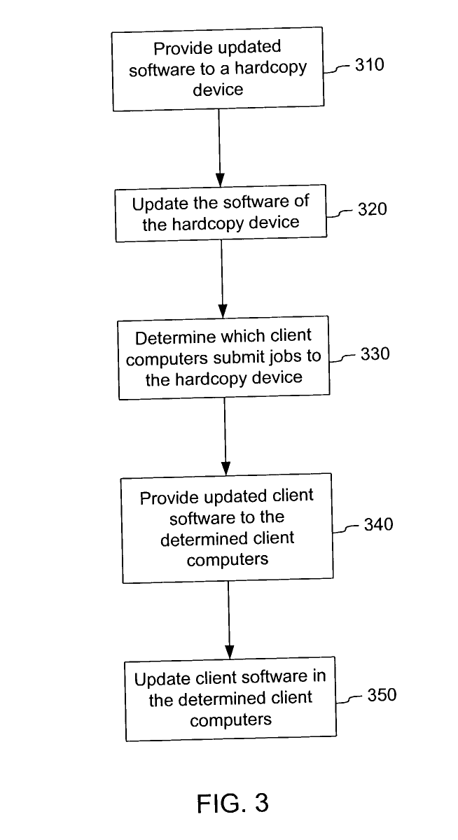

In the process of FIG. 2, the update of the client software in the client PC is initiated in response to a job being submitted to a hardcopy device 30. Consistent with the present invention, it is also possible to update the software in the hardcopy device 30 and client software in the client PCs 10 at substantially the same time. FIG. 3 is a flow diagram for updating software on a hardcopy device and associated client software on client PCs consistent with the present invention. As shown in FIG. 3, updated software is provided to the hardcopy device 30 (step 310). The updated software can be provided to the hardcopy device 30 by the administrator of the network 20 using, for example, the server 40. Alternatively, the updated software can be provided to the hardcopy device by the service station 70. For example, the service station 70 can provide the updated software to the hardcopy device 30 via the public network 60 using the IP address of the hardcopy device 30. The service station 70 and server 40 can also work in combination by which the service station 70 provides the updated software to the server 40, which then provides the updated software to the hardcopy device 30. The software in the hardcopy device 30 is then updated with the updated software (step 320).

In addition to updating the software in the hardcopy device 30, a determination is made of which client PCs 10 submit jobs to the hardcopy device 30 (step 330). The identification of which client PCs 10 submit jobs to the hardcopy device 30 can be stored in a table. Each hardcopy device 30 can maintain a table that identifies which client PCs submit jobs to it. Alternatively, the tables of each hardcopy device 30 can be maintained at a centralized storage location, such as the server 40. The determination of which client PCs 10 submit jobs to the hardcopy device 30 receiving the software update can be made by reference to the table.

For example, a first hardcopy device 30 may have first, second and third client PCs 10 submitting jobs to it, and a second hardcopy device 30 may have second, third and fourth client PCs 10 submitting jobs to it. The table for the first hardcopy device 30 would identify client the first, second and third PCs 10, and the table for the second hardcopy device 30 would identify the second, third and fourth client PCs 10. If the first hardcopy device 30 is having its software updated, then the first, second and third client PCs 10 would be identified from the table as client PCs 10 that submit jobs to the first hardcopy device 30.

After determining which client PCs 10 submit jobs to the hardcopy device receiving the updated software, the updated client software is provided to the determined client PCs 10 (step 340). As described above with respect to FIG. 2, the updated client software can be provided to each of the determined client PCs 10, for example, by the hardcopy device 30 which received the software update, the server 40, or the service station 70. The client software in each of the determined client PCs 10 can then be updated with the updated client software (step 350). This update is preferably done in the background of the client PC 10 so that it does not interrupt the operations of the user of the client PC 10.

The update of the client software in the determined client PCs 10 can be done in an automatic mode without the input or intervention of the users of the determined client PCs 10, as described above with respect to FIG. 2. Alternatively, the update of the client software in the determined client PCs can be performed after requesting and receiving approval by the users at each of the determined client PCs 10, as also described above with respect to FIG. 2.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for updating a version of client software in a client computer, the client software enabling the client computer to communicate properly with a hardcopy device, comprising:
receiving a job from the client computer, the job including information regarding a version of the client software in the client computer;
determining if the version of the client software of the client computer is an up-to-date version; and
providing the up-to-date version of the client software to the client computer if the version of client software of the client computer is not the up-to-date version.

2. A method according to claim 1, wherein the job is received by the hardcopy device.

3. A method according to claim 1, further comprising receiving a software update at the hardcopy device, the software update including an updated version of the client software.

4. A method according to claim 3, further comprising receiving the software update via the Internet.

5. A method according to claim 1, wherein the job is a print job.

6. A method according to claim 1, further comprising updating the client software of the client computer with the provided up-to-date version of the client software.

7. A method according to claim 6, further comprising determining if the updating of the client software is to be updated automatically, wherein the client software is updated automatically based on the determination.

8. A method according to claim 7, further comprising requesting approval of the update if it is determined that the client software is not to be updated automatically.

9. A method according to claim 1, further comprising:
issuing a request for approval to update the client software; and
updating the client software of the client computer with the provided up-to-date version of the client software if approval is indicated.

10. A method for updating a version of client software at one or more client computers, the client software enabling the one or more client computers to communicate properly with a hardcopy device, comprising:
receiving a software update at the hardcopy device, the software update including an updated version of the client software;
determining which of the one or more client computers submits jobs to the hardcopy device; and
updating the client software in each of the determined one or more client computers.

11. A method according to claim 9, further comprising maintaining a table identifying each of the one or more clients which submit jobs to the hardcopy device.

12. A method according to claim 10, wherein the determination is made by reference to the table.

13. A method according to claim 10, wherein the table is maintained at the hardcopy device.

14. A method according to claim 10, wherein the table is maintained at a server.

15. A system for updating a version of client software in a client computer, the client software enabling the client computer to communicate properly with a hardcopy device, comprising:
a processor; and
a memory, coupled to the processor, the memory comprising a plurality of instructions, the plurality of instructions configured to:
receive a job from the client computer, the job including information regarding a version of the client software in the client computer;
determine if the version of the client software of the client computer is an up-to-date version; and
provide the up-to-date version of the client software to the client computer if the version of client software of the client computer is not the up-to-date version.

16. A system according to claim 15, the memory further comprising an instruction configured to receive a software update at the hardcopy device, the software update including an updated version of the client software.

17. A system according to claim 16, the memory further comprising an instruction configured to receive the software update via the Internet.

18. A system according to claim 15, wherein the job is a print job.

19. A system according to claim 15, the memory further comprising an instruction configured to update the client software of the client computer with the provided up-to-date version of the client software.

20. A system according to claim 19, the memory further comprising an instruction configured to determine if the updating of the client software is to be updated automatically, wherein the client software is updated automatically based on the determination.

21. A system according to claim 20, the memory further comprising an instruction configured to request approval of the update if it is determined that the client software is not to be updated automatically.

22. A system according to claim 15, the memory further comprising instructions configured to:
issue a request for approval to update the client software; and
update the client software of the client computer with the provided up-to-date version of the client software if approval is indicated.

23. A hardcopy device configured to update a version of client software at one or more client computers, the client software enabling the one or more client computers to communicate properly with the hardcopy device, comprising:
a processor; and
a memory, coupled to the processor, the memory comprising a plurality of instructions, the plurality of instructions configured to:
receive a software update which includes an updated version of the client software;
determine which of the one or more client computers submits jobs to the hardcopy device; and
update the client software in each of the determined one or more client computers.

24. A hardcopy device according to claim 23, the memory further comprising an instruction configured to maintain a table identifying each of the one or more clients which submit jobs to the hardcopy device.

25. A hardcopy device according to claim 24, the memory further comprising an instruction configured to reference the table to determine which of the one or more client computers submits jobs to the hardcopy device.

26. A hardcopy device according to claim 24, wherein the table is maintained at a server.
